(19) United States
(12) Patent Application Publication
(10) Pub. No.: US 2014/0216191 A1
(43) Pub. Date: Aug. 7, 2014

(54) PINION VIBRATION DAMPING USING VISCOELASTIC PATCH

(71) Applicants: Mathieu Marsaudon, Billere (FR); Philippe Cutuli, Lescar (FR)

(72) Inventors: Mathieu Marsaudon, Billere (FR); Philippe Cutuli, Lescar (FR)

(73) Assignee: TURBOMECA, Bordes (FR)

(21) Appl. No.: 14/343,658

(22) PCT Filed: Sep. 7, 2012
(86) PCT No.: PCT/FR2012/052003

§ 371 Date: Mar. 7, 2014

(30) Foreign Application Priority Data
Sep. 8, 2011 (FR) 11 57991

(51) Int. Cl. F16H 55/06

(52) U.S. Cl. CPC F16H 55/06; F16H 2055/065
USPC 74/434; 156/60

(57) ABSTRACT

A gearwheel extending in an axial direction and in a radial direction, the gearwheel including a radial web carrying an axial annular rim, the rim carrying gear teeth. The web includes a vibration damper device including a layer of viscoelastic material and a backing layer. The layer of viscoelastic material is arranged axially between the radial web and the backing layer, and the layer of viscoelastic material is fixed directly to the web.

### BACKGROUND OF THE INVENTION

The present invention relates to the technical field of gearwheels, and particularly but not exclusively, to those that are to be found in speed-reducing gearboxes of turbine engines. The invention relates more particularly to the problem of damping the vibration that can appear in gearwheels, in particular in the speed-reducing gears of turbine engines or in speed-multiplying gears.

It is well-known that the vibration that is liable to appear in gearwheels driven to rotate at high speed can damage those gearwheels. That is why it is desired to damp such vibration.

To do this, it is known in particular to make use of a split annular metal ring that is placed under the rim carrying the gear teeth. Generally, the metal ring is received in an annular groove formed in the inner peripheral surface of the rim, concentrically about the axis of rotation of the gearwheel.

Although that solution enables vibration to be reduced considerably, it nevertheless presents a potential drawback of giving rise to the ring wearing and to the undesirable appearance of metal filings in the oil circuit.

Another solution is to adapt the shape of the gearwheel to the vibratory behavior, which has the disadvantageous effect of increasing the weight of the gearwheel.

Yet another solution is to use a vibration damper device comprising a viscoelastic material. That solution is described in particular in FR 2 664 667 and GB 2 463 649.

Taken in consideration along the direction of the axis of rotation of the gearwheel, the viscoelastic material is securely fixed between a support member made of steel and a stresser element. The vibration damper device is fixed to the gearwheel via the support member, which is housed under radial stress in an annular groove formed in the rim. That damper device performs damping in shear. A drawback of that device is that metal-on-metal friction between the support member and the rim of the gearwheel can once more give rise to wear and to metal filings.

### OBJECT AND SUMMARY OF THE INVENTION

An object of the present invention is to provide a gearwheel including an improved vibration damper device.

The invention thus relates to a gearwheel extending in an axial direction and in a radial direction, the gearwheel comprising a radial web carrying an axial annular rim, said a rim carrying gear teeth, said web being provided with a vibration damper device, the vibration damper device being constituted by a layer of viscoelastic material and by a backing layer, the layer of viscoelastic material being arranged axially between the radial web and the backing layer, the layer of viscoelastic material being fixed directly to the web.

It can be understood that the web may extend perpendicularly to the axis of rotation of the gearwheel, or that it may form an angle of less than 90° relative to the axis of rotation of the gearwheel. In general, the web forms an angle lying in the range 45° and 90° relative to the axis of rotation of the gearwheel. Preferably, the web forms an angle lying in the range 65° and 90° relative to the axis of rotation of the gearwheel. Naturally, in order to measure this angle, it is always the smallest angle formed between the web and the axis of rotation of the gearwheel that is measured. Below, the terms “radial length” and “axial thickness” are used respectively to designate a length measured parallel to the element in question (e.g. the web or the vibration damper device) in a direction that is substantially a radial (i.e. at an angle lying in the range 0° to 45° relative to the radial direction), and a thickness measured perpendicularly to the elements under consideration in a direction that is substantially axial (i.e. making an angle lying in the range 0° to 45° relative to the axial direction).

The vibration damper device is constituted by only two layers, namely the layer of viscoelastic material and the backing layer (or layer of rigid material). Furthermore, the layer of viscoelastic material is fixed directly to the web, which means that unlike the above-described prior art, there is no support member between the gearwheel and the layer of viscoelastic material.

Another advantage of the invention is that it does not require the presence of an annular groove formed in the gearwheel. The gearwheel of the invention thus has no annular groove receiving the vibration damper device. Specifically, a drawback of such a groove is that it generates a shape discontinuity and a concentration of stresses in a zone that needs to satisfy specific dimensioning requirements, and this can require a significant increase in thickness in order to guarantee mechanical strength for the part. According to the invention, the damper device is fixed directly to the web of the gearwheel. That makes it possible to avoid generating any sudden change in shape and to significantly improve the dimensioning of the gearwheel in terms of weight.

Another advantage of the invention lies in the fact that the damper device has only two layers. Specifically, the greater the number of layers, the more difficult it is to control damping and make it reproducible.

Furthermore, because of the absence of a support member between the layer of viscoelastic material and the gearwheel, the vibration damper device of the invention is not disturbed by the characteristics of the support member.

The inventors have observed with surprise that positioning the damper device of the invention on the web makes it possible to obtain a level of vibration damping that is satisfactory, i.e. a level that is at least equivalent to that which is obtained with the damper devices placed on the rim in the prior art. By being placed on the web, the damper device of the invention makes it possible particularly, but not exclusively, to damp vibration modes of the web and/or combined vibration modes of the web and of the rim.

Furthermore, the invention makes it possible to obtain vibration damping by compression, whereas in the prior art damping is obtained in shear. For a given amplitude of vibration, and independently of the mode and of the element under consideration (the rim or the web), the inventors have observed with surprise that the compression damping obtained by means of the vibration damper device of the invention is just as effective as the shear damping of the prior art.

The vibration modes of the web, or the combined vibration modes of the web and of the rim, give rise to the web deforming in a direction that is substantially axial. The vibration damper device, which is fixed directly on the web, is thus driven by the web in this substantially axial direction. Thus, since the layer of viscoelastic material and the backing layer are arranged in succession in a direction perpendicular to the web and substantially parallel to the direction in which the web deforms, the backing layer, by means of its inertia, exerts a traction/compression force on the layer of viscoelastic material that opposes the deformation movements of the web. The axial vibratory movement of the web, and more generally of the gearwheel, are thus counterbalanced and attenuated. Naturally, when the axis of rotation of the gearwheel is arranged substantially horizontally (relative to the gravity direction), the damping effect of the damper device may also present a component in shear, in particular because of the mass of the backing layer. Nevertheless, damping is performed for the most part by the axial component (i.e. in compression) of the reaction of the damper device to the vibration modes of the gearwheel.

Thus, by means of the invention, it is possible to reduce the thicknesses of the various elements of the gearwheel, and in particular the axial thickness of the web, compared with prior art gearwheels, thereby enabling the weight of the gearwheel to be reduced. Furthermore, since the thickness of the web is smaller (and the web is thus lighter) than in prior art gearwheels, there is no need to make possible holes through the web in order to reduce its weight, where such holes generally give rise to unbalance and reduce the stiffness and the mechanical strength of said web.

Advantageously, the vibration damper device is annular in shape. The damper device may be in the form of a ring that is continuous, split, or indeed in multiple segments.

Furthermore, the backing layer preferably presents a radial length that is not less than the radial length of the layer of viscoelastic material, enabling the backing layer to cover the viscoelastic material radially, thereby serving to protect it. Nevertheless, the backing layer could equally present a length that is less than the length of the viscoelastic material. By way of example, the radial length of the vibration damper device may lie in the range 5 millimeters (mm) to 15 mm, for a radial web having a radial length of 35 mm.

Preferably, the layer of viscoelastic material presents an axial thickness lying in the range 0.1 mm to 3 mm. Naturally, the thickness of the layer of viscoelastic material should be adapted to the frequencies for damping. Also preferably, the backing layer presents an axial thickness lying in the range 0.5 mm to 2 mm. Still more preferably, the backing layer presents axial thickness of about 1 mm.

As material for constituting the backing layer, it is preferable to select a material that is more rigid than the material of the viscoelastic layer. For the backing layer, it is possible in particular to select a metal material, e.g. a steel, or any other rigid material such as a composite material, or indeed a plastics material. The viscoelastic material is preferably an elastomer.

Preferably, the gearwheel includes a hub, the vibration damper device being arranged closer to the annular rim than to the hub. Thus, the damper device is arranged where the deformation of the web has its greatest amplitude, thereby improving the reaction of the damper device, in particular to axial vibration of the web. The damping of vibration in the gearwheel, in particular in the web or in the assembly comprising the web and the rim, is thus improved.

Preferably, the radial web is substantially frustoconical in shape, the vibration damper device being placed on the inner side of the frustoconical shape.

It can be understood that when the web forms an angle of less than 90° relative to the axis of rotation of the gearwheel, the web presents the general shape of a truncated cone (i.e. it is frustoconical in shape). Thus, a web that presents a shape that is “substantially frustoconical” is a web that presents at least one region of annular shape that slopes relative to the axis of rotation of the gearwheel, this sloping annular shape possibly presenting an axial section (section in a plane containing the axis of the substantially frustoconical shape) that is concave (bowl shaped), convex (in the shape of a trumpet bell), or a rectilinear (frustoconical shape), or a shape that is intermediate between these shapes. By placing the damper device inside the truncated cone formed by the web, the compression damping effect is improved, in particular because of the centrifugal forces due to the gearwheel rotating.

Naturally, in a variant, the gearwheel includes at least two vibration damper devices. These two damper devices may be arranged on the same side of the web, or they may be arranged on opposite sides of the web (i.e. on both sides of the web). In another variant, the gearwheel presents one or more damper devices fixed to the web, and one or more devices fixed to the rim (in particular on an axial peripheral surface of the rim).

In an advantageous embodiment of the invention, the gearwheel is a pinion, e.g. an outlet speed-reducing gear or an intermediate speed-reducing gear of a turbine engine.

The invention also provides a turbine engine, e.g. a helicopter turbine engine, including a gearwheel of the invention, said gearwheel then being a speed-reducing pinion.

The invention also provides a method of fabricating a gearwheel of the invention, said method including a step of vulcanizing the layer of viscoelastic material on the radial web.

Preferably, a gearwheel is provided (initially not having a vibration damper device), a vibration damper device is provided that is constituted by a layer of viscoelastic material and by a backing layer, these two layers previously being securely fixed to each other, and the viscoelastic material is vulcanized on the surface of the radial web so as to bond the damper device to the gearwheel.

In a variant, the fabrication method may also involve vulcanizing the viscoelastic material simultaneously to the backing layer and to the surface of the web of the gearwheel.

In another variant, the method of fabricating a gearwheel includes a step of adhesively bonding the layer of viscoelastic material on the radial web. A film of adhesive is thus present between the layer of viscoelastic material and the web.

### BRIEF DESCRIPTION OF THE DRAWINGS

The invention can be better understood on reading the following description of an embodiment of the invention given by way of nonlimiting example and with reference to the accompanying drawings, in which:

FIG. 1 shows a helicopter turbine engine including a gearwheel of the invention;

FIG. 2 is an axial section view of a gearwheel of the invention including a vibration damper device;

FIG. 3 is a detail view of FIG. 2 showing the vibration damper device; and

FIG. 4 is a fragmentary perspective view of the FIG. 2 gearwheel.

### DETAILED DESCRIPTION OF THE INVENTION

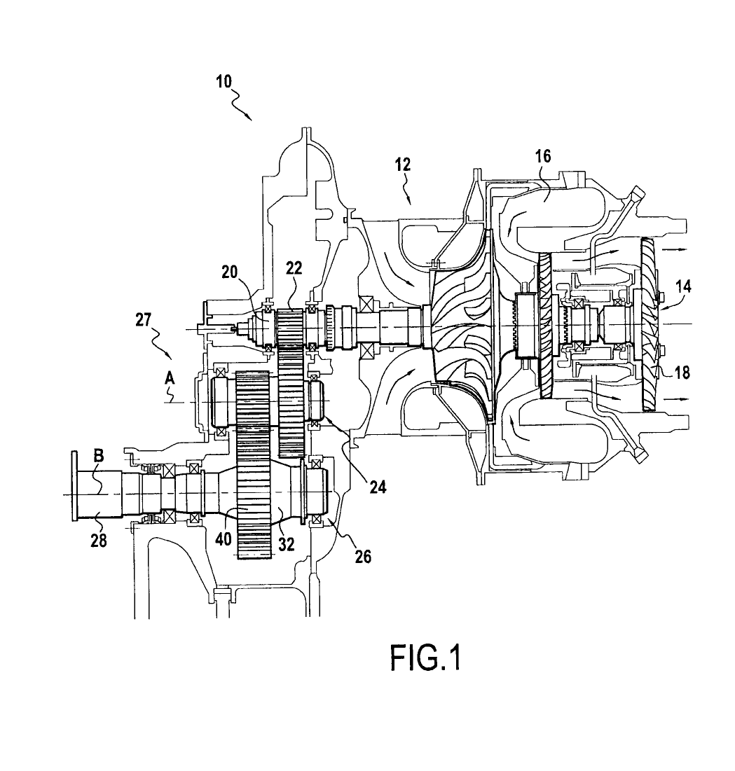

FIG. 1 shows a turbine engine 10, specifically a helicopter turbine engine. In conventional manner, this turbine engine 10 comprises a gas generator 12 and a free turbine 14 driven in rotation by the stream of combustion gas leaving the combustion chamber 16. The free turbine 14 has a turbine wheel 18 that is fastened to one of the ends of a shaft 20. At the other end of the shaft 20 there is a primary pinion 22 that meshes with an intermediate pinion 24. The intermediate gear 24, which is driven in rotation about its axis A by the primary gearwheel 22, meshes with an outlet pinion 26 in accordance with the present invention. The intermediate gear 24 and the outlet gear 26 are gear wheels forming part of the speed-reducing gearing 27 of the turbine engine 10. The outlet gear 26, driven in rotation about its axis B by the intermediate gear 24, is connected to an outlet shaft 28 for coupling to the main gearbox of the helicopter (not shown herein).

Naturally, the invention could be applied to other types of engine and turbine engine, e.g. to turbine engines in which the turbines are linked.

While the turbine engine is in operation, the intermediate gear 24 and the outlet gear 26 are subjected to vibration. As mentioned above, the object of the invention is to damp that vibration.

In this example, the outlet gear 26 is thus a gearwheel in accordance with the invention. Without going beyond the ambit of the invention, the intermediate gear 24 could also be a gearwheel of the present invention. In other words, the invention may be applied to the intermediate gear 24 and/or to the outlet gear 26.

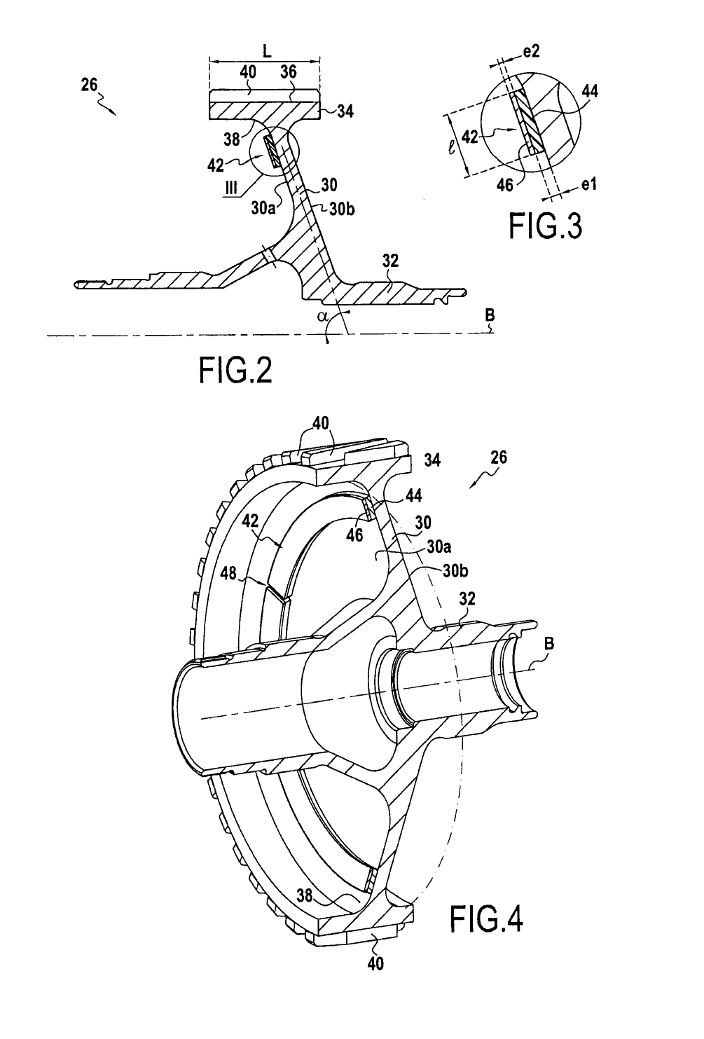

With reference to FIG. 2, there follows a description in greater detail of the outlet gear 26 in accordance with the invention.

As can be seen in this axial section view, the outlet gear 26 conventionally comprises a radial web 30 extending radially between a hub 32 and an annular rim 34. The web 30 forms an angle α of less than 90° relative to the axis of rotation B of the gear 26. In this example, α=70°.

The annular rim 34 has a first peripheral surface, namely an outer peripheral surface 36, and a second peripheral surface, namely an inner peripheral surface 38. The inner and outer peripheral surfaces extend in annular manner around the axis B. With reference to FIG. 4, it can be seen that the outer peripheral surface 36 carries gear teeth 40.

The radial web 30 is frustoconical in shape and has an inner frustoconical surface 30a on the inside of the frustoconical shape and an outer frustoconical surface 30b on the outside of the frustoconical shape.

In accordance of the present invention, the inner frustoconical surface 30a is provided with a vibration damper device 42 that is constituted by a layer of viscoelastic material 44 and by a backing layer 46. In other words, the vibration damper device 42 has only two layers. Still in accordance with the invention, the layer of viscoelastic material 44 is arranged axially (i.e. along the direction defined by the axis B) between the web 30, and more particularly the inner frustoconical surface 30a of the web 30, and the backing layer 46. It can thus be understood that, in this nonlimiting example, the layer of viscoelastic material is fixed both to the inner frustoconical surface 30a and to the backing layer 46.

As can be seen in FIG. 3, in accordance with the invention, the layer of viscoelastic material 44 is fixed directly to the inner frustoconical surface 30a of the web 30, i.e. there is no coupling member between the layer of viscoelastic material 44 and the web 30. Furthermore, the gear 26, and more particularly the web 30, does not have an annular groove.

In order to fabricate the outlet gear 26 of the invention, a step is performed of fastening the vibration damper device 42 to the radial web 30 by adhesive or by vulcanizing the layer of viscoelastic material 44 against the inner frustoconical surface 30a of the radial web 30, it being specified that the outlet gear 26 is made of metal.

Thus, when the damper device 42 is stuck to the web 30, it can be understood that a film of adhesive may exist between the layer of viscoelastic material 44 and the inner frustoconical surface 30a of the web 30.

Furthermore, the backing layer 46 may be adhesively bonded or vulcanized to the layer of viscoelastic material 44.

The layer of viscoelastic material 44 is vulcanized to the inner frustoconical surface 30a of the web 30.

With reference to FIG. 4, it can be seen that the vibration damper device 42 presents an annular shape, extending over practically an entire annular strip of the inner frustoconical surface 30a of the radial web 30. The vibration damper device 42 is advantageously split, i.e. it presents a slot 48 extending preferably across the entire axial thickness and the entire radial length of the damper device 42. One advantage is to improve the ability of the backing layer 46 to adapt to the shape and to the deformations of the wheel in order to improve the absorption of vibration.

As can be seen in FIG. 3, the backing layer 46 presents a radial length l that is substantially equal to the length of the layer of viscoelastic material 44. The radial length l of the backing layer 46 might be slightly greater than that of the layer of viscoelastic material 44. The fact that the backing layer 46 covers the layer of viscoelastic material 44 in the radial direction serves to protect it in order to limit interactions with and attacks from the surrounding environment (transport, handling, contact with fluid, etc. . . . ).

In this example, the vibration damper device 42 is arranged radially closer to the annular rim 34 than to the hub 32. Nevertheless, it could be arranged radially in some other zone in order to damp particular deformation modes of the web 30.

By way of nonlimiting example, the axial thickness e1 of the layer of viscoelastic material 44 lies in the range 0.5 mm to 3 mm, while the axial thickness e2 of the backing layer 46 lies in the range 0.5 mm to 2 mm. The thicknesses may be selected as a function of the dimensions of the gear 26, of the frequencies to be damped, and of the component materials selected for the two above-mentioned layers. In this example, the viscoelastic material is an elastomer of the nitrile type, while the backing layer is made of steel, it being understood that it may optionally be possible to select some other material, e.g. a metal, a composite material, or indeed a plastics material.

The radial length l of the vibration damper device 42 (in this example equal to the radial length of the layer of viscoelastic material and of the backing layer) lies in the range 5 mm to 15 mm, and is thus substantially greater than its thickness.

The layer of viscoelastic material 44 works in compression. It is thus possible to obtain damping by compression of vibration over a frequency range extending from about 5 kilohertz (kHz) to 30 kHz. Damping vibration provides the possibility of significantly reducing the weight of the outlet gear 26, in particular by reducing the thickness of the rim, of the web, and/or of the hub. The saving in weight is about 20% for the outlet gear 26. The same result can be obtained for the intermediate gear 24.

1-9. (canceled)

10: A gearwheel extending in an axial direction and in a radial direction, the gearwheel comprising:
a radial web carrying an axial annular rim, the rim carrying gear teeth;
wherein the web includes a vibration damper device including a layer of viscoelastic material and a backing layer, the layer of viscoelastic material being arranged axially between the radial web and the backing layer, and the layer of viscoelastic material being fixed directly to the web, and
wherein the radial web is substantially frustoconical in shape, the vibration damper device being placed on an inner side of the frustoconical shape.

11: A gearwheel according to claim 10, wherein the vibration damper device is in a form of a ring that is continuous, split, or in multiple segments.

12: A gearwheel according to claim 10, wherein the backing layer presents a radial length that is at least equal to a length of the layer of viscoelastic material.

13: A gearwheel according to claim 10, wherein the layer of viscoelastic material presents an axial thickness in a range of 0.1 mm to 3 mm.

14: A gearwheel according to claim 10, wherein the backing layer presents an axial thickness in a range of 0.5 mm to 2 mm.

15: A gearwheel according to claim 10, further comprising a hub, and wherein the vibration damper device is arranged closer to the annular rim than to the hub.

16: A turbine engine comprising a gearwheel according to claim 10, wherein the gearwheel is a pinion.

17: A method of fabricating a gearwheel according to claim 10, comprising vulcanizing the layer of viscoelastic material on the radial web.

18: A method of fabricating a gearwheel according to claim 10, comprising adhesively bonding the layer of viscoelastic material on the radial web.
